(19) United States
(12) Patent Application Publication
(10) Pub. No.: US 2011/0125647 A1
(43) Pub. Date: May 26, 2011

(54) TRANSMISSION INFORMATION LINKUP SYSTEM

(75) Inventors: KANAKO NAKASA, KAWASAKI (JP); KAZUHIKO IWAI, KAWASAKI-SHI (JP)

(73) Assignee: FUJITSU LIMITED, Kawasaki (JP)

(21) Appl. No.: 12/783,905

(22) Filed: May 20, 2010

Related U.S. Application Data
(63) Continuation of application No. PCT/JP2007/072658, filed on Nov. 22, 2007.

(51) Int. Cl. G06Q 30/00; H04L 9/28; G06F 15/16

(52) U.S. Cl. 705/50; 705/26.1; 709/203

(57) ABSTRACT

A transmission information linkup system with which users can transmit the information in linkage for purchasing the commercial product etc. The transmission information linkup system includes a server and a first terminal. The first terminal includes a unit to receive an input form from the server, a unit to input information to the input form, corresponding to a user's operation, a unit to transfer at least apart of the input form to a second terminal, a unit to receive input information to the input form from the second terminal, and a unit to transmit the input information received from the second terminal and the input information corresponding to the user's operation as input information to the input form to the server. And the server includes a unit to transmit the input form to the first terminal and a unit to receive the input information from the first terminal.

### CROSS-REFERENCE TO RELATED APPLICATION

This is a continuation of Application PCT/JP2007/072658, filed on Nov. 22, 2007, now pending, the entire contents of which are herein wholly incorporated by reference.

### FIELD

The present invention relates to a technology of transmitting information in linkage for online shopping via a communication network such as the Internet.

### BACKGROUND

Over the recent years, an online shop (virtual shop) for selling a variety of commercial products via the Internet has been widely utilized.

An electronic commerce transaction in which bidirectional communications are performed via the Internet between a server (web server) on the side of the online shop and a terminal on a client side which makes an application for purchasing the commercial product, enables a desired commercial product to be purchased anytime without any restrictions from a terminal in user's home etc and therefore spreads rapidly.

Further, for example, the technologies disclosed in the following Patent documents 1-3 are given as the related arts to the invention of the present application.

[Patent document 1] Japanese Patent Laid-Open Publication No. 2001-333411
[Patent document 2] Japanese Patent Laid-Open Publication No. 2002-232861
[Patent document 3] Japanese Patent Laid-Open Patent Publication (Translation of PCT Application) No. 2003-516045

The user must, however, transmit a large quantity of information such as a delivery address for the commercial product, a name, a telephone number and a settlement method to the online shop, and an input operation thereof is time-consuming.

Especially, on the occasion of sending a gift, such a case arises that the sender wants a recipient user to input items of information about the delivery address, i.e., an address of the user receiving the gift and a color and a pattern of the commercial product.

Furthermore, there is also a case in which a plurality of users wants to purchase while discussing as in the case of group-purchasing, performing BTO (Build To Order) in a way that receives advices from others, however, the conventional online shop disables the plurality of users from making one order by inputting from on different terminals respectively.

### SUMMARY

According to an aspect of the invention, a transmission information linkup system includes a first terminal having:

a receiving unit to receive an input form from a server;

an input unit to input information to the input form, corresponding to a user's operation;

a transferring unit to transfer at least apart of the input form to a second terminal;

a re-receiving unit to receive input information to the input form from the second terminal; and

a transmitting unit to transmit, to the server, the input information received from the second terminal and the input information corresponding to the user's operation as input information to the input form, and

the server having a transmitting unit to transmit the input form to the first terminal, and a receiving unit to receive the input information from the first terminal.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a schematic view depicting an online shopping system by way of a first embodiment;

FIG. 2 is a schematic diagram illustrating one example of a first terminal in the first embodiment;

FIG. 3 is a function block diagram of the first terminal.

FIG. 4 is a schematic diagram of a server;

FIG. 5 is an explanatory diagram of a transmission information linkup method by way of the first embodiment;

FIG. 6 is a diagram illustrating an example of displaying a purchase form;

FIG. 7 is an explanatory diagram of a first modified example of the linkup method;

FIG. 8 is a diagram illustrating one example of a selection form;

FIG. 9 is a diagram illustrating one example of a purchase form in a format of adding a commercial product;

FIG. 10 is a diagram illustrating one example of the purchase form provided with encryption buttons;

FIG. 11 is a schematic diagram of the first terminal in a second embodiment;

FIG. 12 is an explanatory diagram of the transmission information linkup method by way of the second embodiment;

FIG. 13 is an explanatory diagram of a fourth modified example of the linkup method; and

FIG. 14 is a diagram illustrating one example of a transmission mail.

### DESCRIPTION OF EMBODIMENT(S)

### First Embodiment

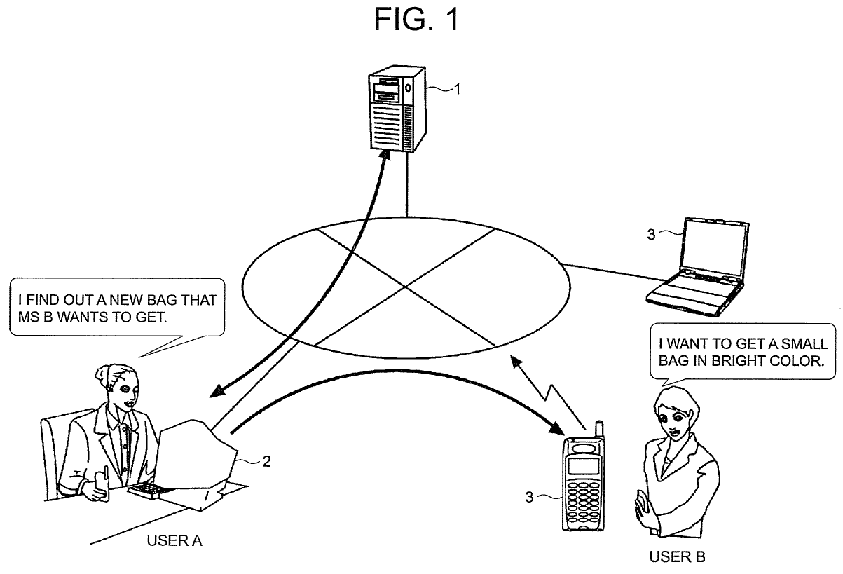

FIG. 1 is a schematic view of an online shopping system by way of a first embodiment.

An online shopping system 10 in the first embodiment is a transmission information linkup system in which a plurality of users links up with each other to transmit information for purchasing commercial products to a server, and is configured by a server 1 and a plurality of first terminals 2, which are connected to each other via a network.

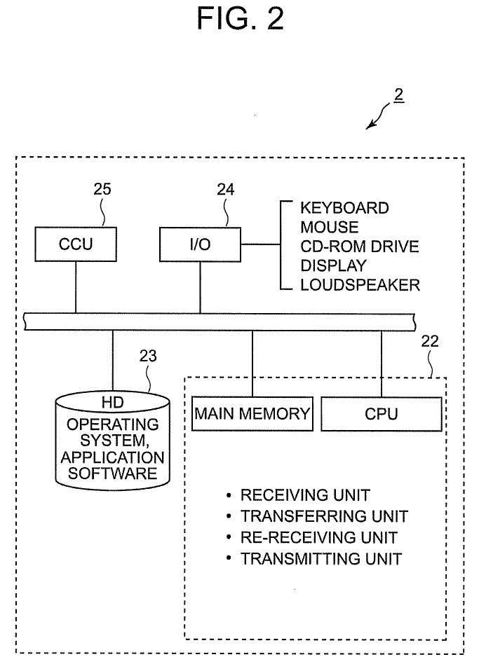

FIG. 2 is a schematic diagram illustrating one example of the first terminal 2. The terminal 2 is a general-purpose computer including an arithmetic processing unit 22 constructed of a CPU (Central Processing Unit), a main memory, etc., a storage unit (hard disk) 23 stored with data and software for arithmetic processes, an input/output (I/O) port 24, a communication control unit (CCU) 25, and so on.

To the I/O port 24, input devices (input units) such as a keyboard, a mouse and a CD-ROM drive and output devices such as a display device and a printer are properly connected.

The CCU 25 performs communications with other computers via the network.

The storage unit 23 is preinstalled with an operating system (OS) and application software (a transmission information linkup program).

The arithmetic processing unit 22 properly reads the OS and the application program from the storage unit 23 and executes the OS and the application program, thereby functioning also as a receiving unit, a transferring unit, a re-receiving unit and a transmitting unit by arithmetically processing the information inputted from the I/O port 24 and the CCU 25 and the information read from the storage unit 23.

The receiving unit receives an input form for purchasing the commercial product from the server 1.

The transferring unit transfers a transfer form, into which the input form or at least a part of the input form is converted, to another terminal (second terminal) 3.

The re-receiving unit receives input information with respect to the input form from the second terminal.

The transmitting unit transmits, to the server, the input information received from other terminals and the input information corresponding to a user's operation as the input information to the input form.

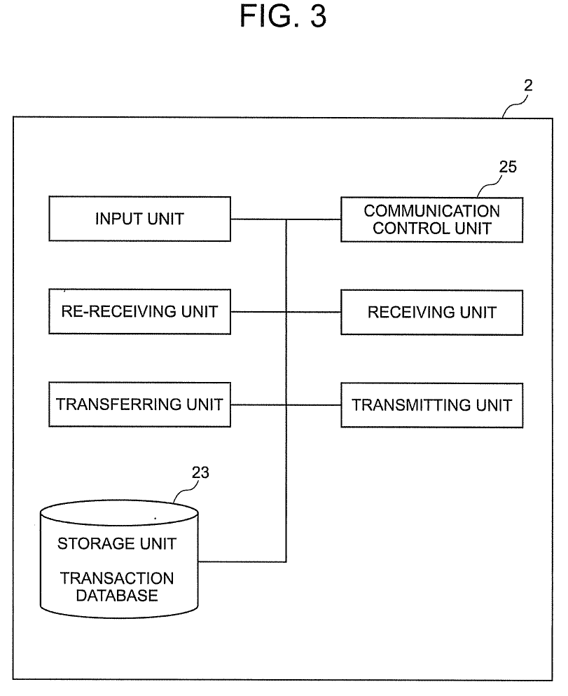

The terminal illustrated in FIG. 2 is a device which realizes softwarewise functions of the respective units in such a way that the arithmetic processing unit constructed of the CPU, the memory, etc. executes the transmission information linkup program according to the present invention, however, this terminal may, without being limited to this type of device, also be an electronic device including, as illustrated in FIG. 3, electronic circuits which are dedicatedly designed as the input unit, the receiving unit, the transferring unit, the re-receiving unit and the transmitting unit to thereby realize hardwarewise the same functions as those of the terminal.

Further, the second terminal 3 is a device having a function of receiving the input form or the transfer form by performing the communications with the first terminal 2, and sending the input information to the form back to the first terminal. This function can be realized by a web browser or a mailer on the device such as a general type of personal computer, a mobile phone and a PDA.

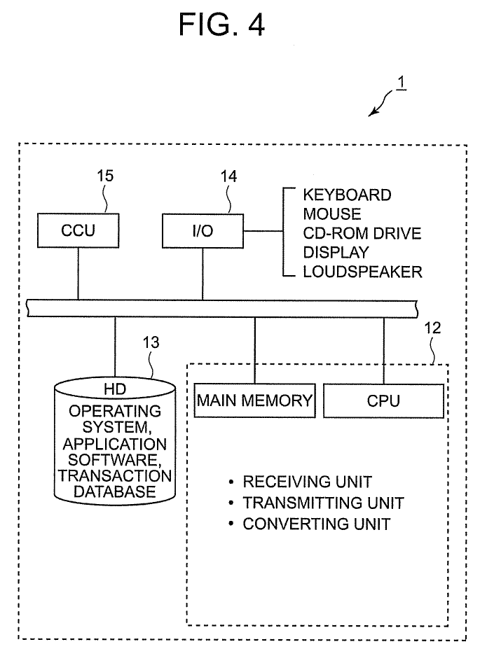

FIG. 4 is a schematic diagram of the server 1, which provides a web service for shopping via the network. As depicted in FIG. 4, the server 1 is a general-purpose computer including an arithmetic processing unit 12 constructed of a CPU (Central Processing Unit), a main memory, etc., a storage unit (hard disk) 13 stored with data and software for the arithmetic process, an input/output (I/O) port 14, a communication control unit (CCU) 15, and so on.

The input devices such as the keyboard, the mouse and the CD-ROM drive and the output devices such as the display device and the printer are properly connected to the I/O port 14.

The CCU 15 performs the communications with other computers via the network.

The storage unit 13 is preinstalled with the operating system (OS) and the application software. Further, the storage unit 13 retains a transaction database stored with pieces of ordering information of the commercial products etc.

The arithmetic processing unit 12 properly reads the OS and the application program from the storage unit 13 and executes the OS and the application program, thereby functioning also as a transmitting unit, a receiving unit and a converting unit by arithmetically processing the information inputted from the I/O port 14 and the CCU 15 and the information read from the storage unit 13.

The transmitting unit transmits a commercial product purchase form (input form) in response to a request given from the first terminal.

The receiving unit receives the input information to the purchase form from the first terminal 2, and stores the input information as ordering information of a commercial product in the transaction database. Further, the receiving unit, when receiving notification of transferring the purchase form of the commercial product from the first terminal 2, stores a reservation flag of the commercial product in the transaction database of the storage unit 13, thereby setting the relevant commercial product in a layaway status.

The converting unit, when receiving notification of transferring the input form from the first terminal 2, converts a transmitting destination of the input information to at least a part of the input form into a terminal address, thus generating a transfer form.

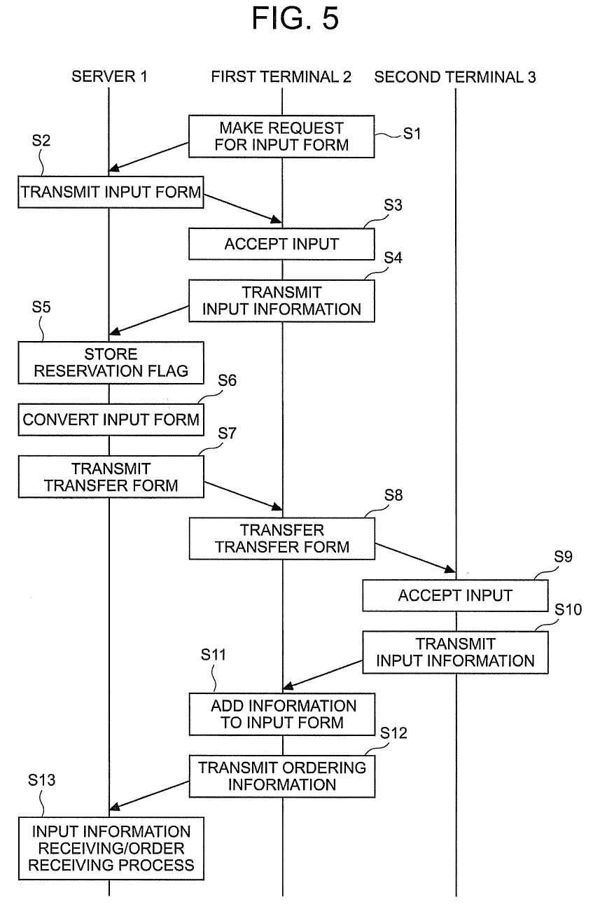

The following is discussion on a transmission information linkup method between the thus-configured server 1 and first terminal 2. FIG. 5 is an explanatory diagram of the transmission information linkup method by way of the embodiment.

A user of the first terminal 2 browses a shopping site of the server 1 and selects a purchase of the commercial product, in which case the first terminal 2 requests the server 1 for the purchase form (input form) (step 1, which will hereinafter be also abbreviated to as S1).

The transmitting unit of the server 1 receiving the request transmits the purchase form (HTML file) to the requester terminal 2 (S2).

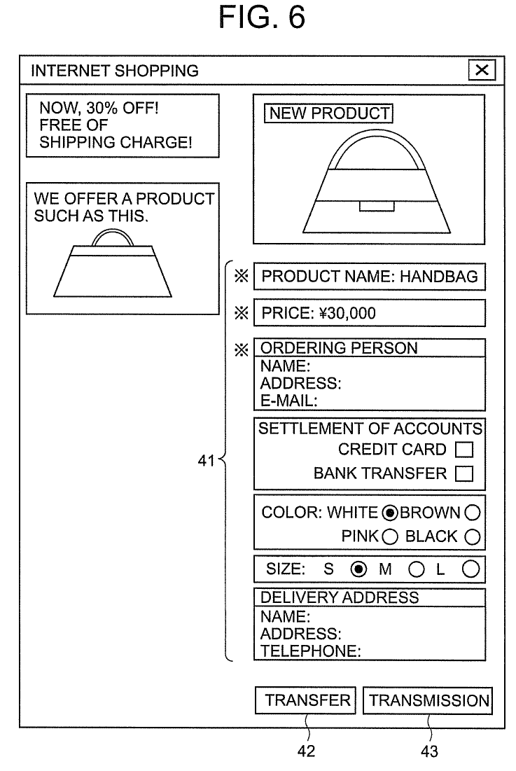

The first terminal 2, the receiving unit of which receives the purchase form, displays the purchase form on the display unit as in FIG. 6. When the user performs inputting by operating the input unit such as the keyboard and the mouse, the terminal 2 receives this input as the input information to respective input fields 41 of the purchase form, and displays the input information in the relevant input fields (S3).

Then, if the user wants to input in linkage with other users, after inputting several entries to the predetermined fields (marked with in the drawing) among the input fields 41, selects a transfer button 42. When displaying a selection menu and selecting the transfer to other terminals, the terminal 2 transmits, to the server 1, information for notifying of the transfer (transfer notification) and the input information to the input fields 41 (S4).

The server 1 receiving the transfer notification, even when the input information to the purchase form is not transmitted for a long period of time, does not deem that this event is a target of timeout. Further, the server 1 stores the reservation flag together with the input information in the transaction database. With this contrivance, the user discusses with other users while transferring the purchase form, during which the server 1 sets a status of the commercial product specified by the input information to the layaway status (a reserved status). For example, stock information is displayed in a way that subtracts the commercial product set in the reserved status therefrom (S5).

Moreover, the converting unit of the server 1 converts the purchase form into the transfer form (S6). For instance, the input information is transmitted to the server 1 in the case of selecting a transmission button 43 in the purchase form, however, a description of the HTML is changed so that the input information is transmitted to the first terminal 2 in the case of selecting the transmission button 43 in the transfer form. To be specific, the description is changed so as to transmit the information to an IP address of the first terminal 2 that is acquired via the communication control unit 15 or to a mail address of the first terminal 2 that is received as the input information.

For example, in the case of sending back the information by mail, the description is given as follows.

<FORM action = ”mailto:mail address of first terminal?subject
= subject of replay mail & body = input information” method =
”POST”>
<div align = ”right”><INPUT type = ”submit” value =
”transmit”></div></FORM>

At this time, identifying information for specifying the transferred form is described in the “subject”, and variable that will be substituted from input information of the respective input items is described in the “body”.

Further, the converting unit inputs the input information received from the first terminal 2 to the respective input fields in the transfer form.

Next, the transmitting unit of the server 1 transmits the transfer form to the first terminal 2 (S7).

The first terminal 2 receiving the transfer form transfers the transfer form to the second terminal 3 (S8). For instance, the transmitting unit, in the case of detecting the reception of the transfer form, displays a message prompting the user to input the mail address of the transfer destination, transfers the transfer form to the inputted transfer destination, i.e., transmits the mail attached with the transfer form.

The user of the second terminal 3 receiving the mail performs inputting to the input fields 41 while displaying the attached file on the web browser and, after completing the input, selects the transmission button 43. Upon this user's operation, the second terminal 3 accepts the input information to the respective input fields 41 (S9), and transmits the input information to the first terminal 2 (S10).

For example, if a link destination in the case of selecting the transmission button 43 is set as the IP address, the web browser transmits the input information to the IP address, i.e., establishes a connection with the first terminal 2 and thus transmits the input information to the first terminal 2.

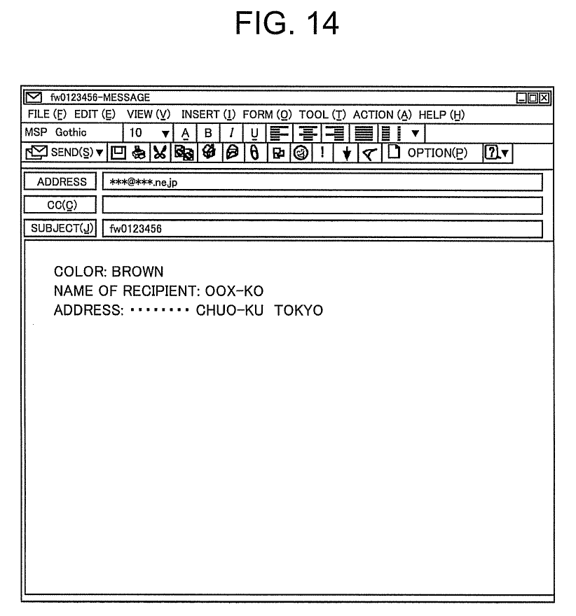

Moreover, if a mailto function is, as in the example stated above, described in the operation in the case of selecting the transmission button 43, the transmission button 43 is selected, at which time specified mail software (mail handler) is booted in a status where “address”, “subject”, “body” and “sender” are inputted as in FIG. 14, and the mail is transmitted when the user selects the “SEND”.

The re-receiving unit of the first terminal 2, when receiving the input information from the second terminal 3, inputs the input information to the respective input fields in the purchase form, thus displaying the input information (S11).

Then, when the user checks the input information inputted thereto and selects the transmission button 43, the transmitting unit of the first terminal 2 transmits, to the server 1, the information (ordering notification) for notifying of ordering together with the respective items of input information (S12).

The server receiving the ordering notification stores the respective items of input information in the database, updates the reservation flag of the relevant commercial product, and changes the status to an ordering status from the reserved status (S13).

Note that the embodiment has exemplified the example of transferring the input form to between the two terminals, however, if the second terminal 3 receiving the input form or the transfer form has the same function as that of the first terminal 2, the second terminal 3 may further transfer the received form to another terminal.

Thus, according to the embodiment, the plurality of users can input the input form in linkage with each other, whereby the plurality of users (the persons concerned: purchasers) can directly input the input information in the case of purchasing gifts and purchasing articles for common use.

### First Modified Example

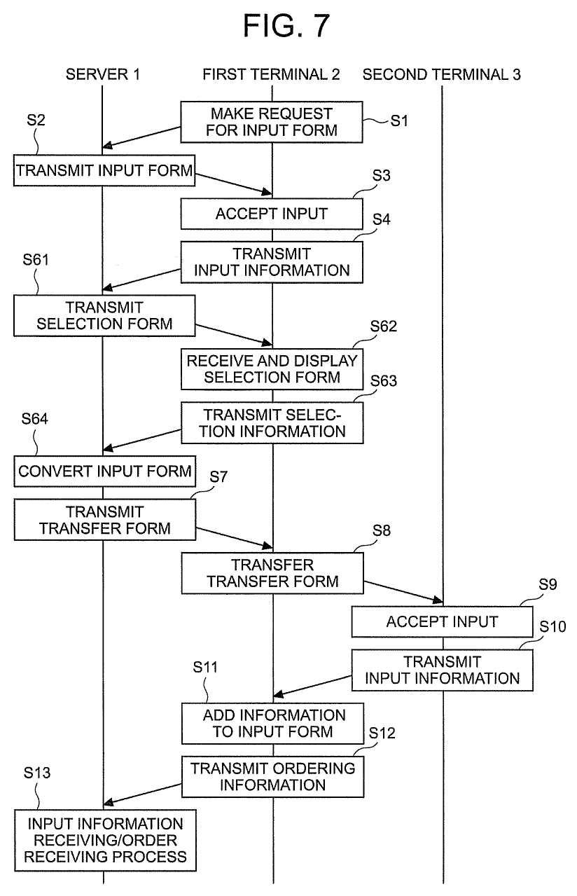

FIG. 7 is an explanatory diagram of a first modified example. In the first embodiment discussed above, the same contents are displayed in the purchase form and in the transfer form, however, the first modified example enables the display contents to be selected on the first terminal 2. Note that other configurations are the same as in the first embodiment discussed above.

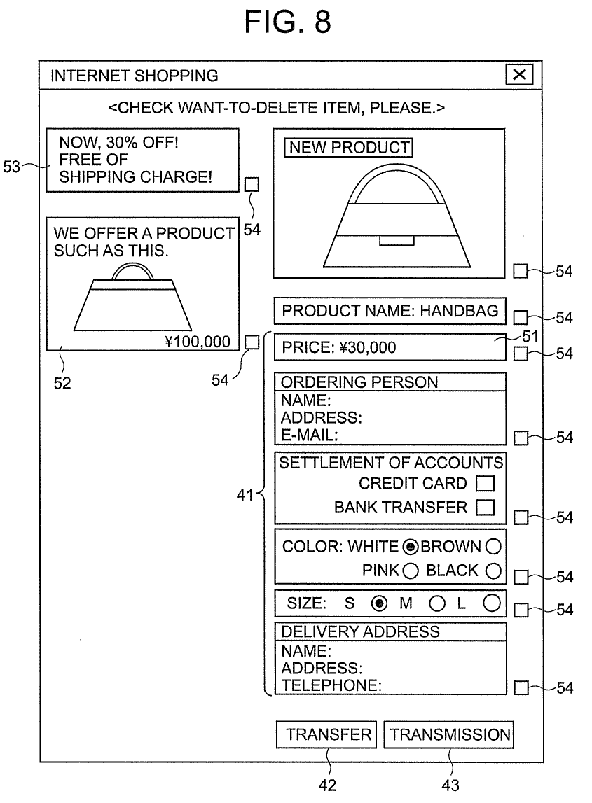

After executing steps 1-4 in the same way as described above, the server 1 in the first modified example receives the transfer notification and the input information from the first terminal 2, then stores the reservation flag together with the input information in the transaction database (not depicted in FIG. 7), and transmits a selection form to which the received input information is inputted as illustrated in FIG. 8 to the first terminal 2 (S61).

This selection form is a form which includes a price box 51, a related product display box 52, a discount information display box 53, etc. and the selection items (the check boxes in this modified example) 54 added to the predetermined information fields. The selection form may be stored together with the purchase form in the storage unit 13 beforehand, and the converting unit may generate the selection form by converting the purchase form in a way that adds the selection items 54 to the purchase form. Moreover, the converting unit may execute the conversion of adding the selection items 54 to the input fields to which the input information received from the first terminal is inputted.

The first terminal 2 receives the selection form and displays this selection form on the display unit (S62). Then, when the user selects the check box(s) of the input field(s) that the user wants to delete from the transfer form and chooses a determination button 55, the first terminal 2 transmits, to the server 1, information (selection information) indicating which check box is selected (S63).

The converting unit of the server 1 receiving the selection information deletes, based on this selection information, the checked field(s) from the purchase form, and converts the purchase form into the transfer form in the same way as step 6 described above (S64).

Then, the transmitting unit of the server 1 transmits the transfer form to the first terminal 2 and executes the processes from step 7 onward in the same way as described above.

Thus, according to the first modified example, the user of the first terminal 2 deletes the desired field(s) and can transfer the transfer form to the user of the second terminal 3, whereby the display of a related commercial product priced over a budget and arbitrary items of information such as the price can be concealed.

It should be noted that the information selected by the user is deleted in the first modified example, however, an available scheme is that the information selected by the user may remain undeleted.

### Second Modified Example

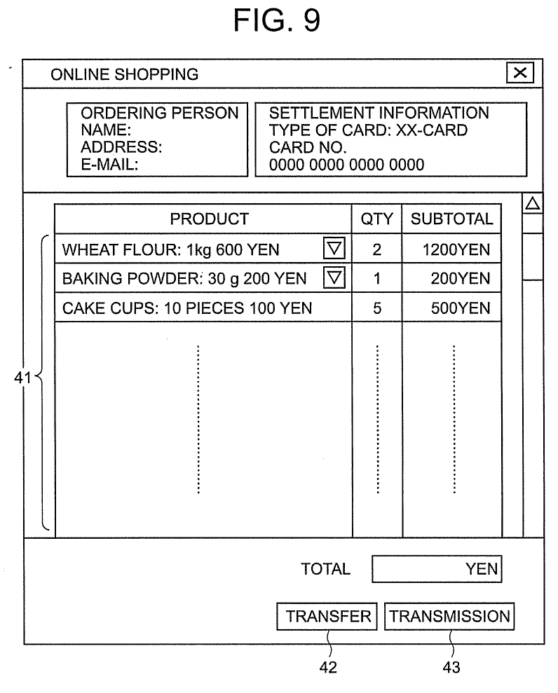

The first embodiment has exemplified the example of the purchase form for one piece of commercial product, however, a second modified example takes, as illustrated in FIG. 9, a purchase form (input form/purchase form) in a format of adding the commercial products purchased by the individual users. Incidentally, in this case, the server 1 may omit the process of storing the reservation flag, i.e., the layaway process. Other configurations are the same as those in the first embodiment or the first modified example.

When the first terminal 2 receives the purchase form (S3) and when the user inputs the commercial product to be purchased and selects the transfer button, the first terminal 2 transmits the information for notifying of the transfer (the transfer notification) and the input information in the input fields 41 to the server 1 (S4).

The converting unit of the server 1 receiving the transfer notification converts the purchase form into the transfer form similarly to the first embodiment discussed above (S6), then transmits the transfer form to the first terminal 2, and executes the processes from step 7 onward in the same way as described above.

Moreover, if the second terminal 3 receiving the input form or the transfer form has the same function as the first terminal 2 has, the second terminal 3 may transfer the received form to further another terminal.

Thus, according to the second modified example, the purchase form (input form/purchase form) can be relayed among the plurality of users, and hence the input on the occasion of group-purchasing the commercial product is facilitated. For example, only the user of the first terminal inputs the delivery address and the settlement-of-accounts information, thereby enabling the input processes of other users to be omitted. Further, the commercial products, which are of a small-lot production of a wide variety of products but are not worth a sole purchase because of an increased cost for shipping as in the case of confectionary materials and handicraft materials, can be purchased on a group basis.

### Third Modified Example

In the first embodiment, the input information is transmitted without being encrypted to between the second terminal 3 and the first terminal 2, however, a third modified example involves encrypting the input information and transmitting the encrypted input information.

The server 1 in the third modified example, when the transmitting unit transmits the input form or the transfer form to the first terminal 2, transmits key information, and the second terminal 3 encrypts the input information by use of the key information and transmits back the encrypted input information.

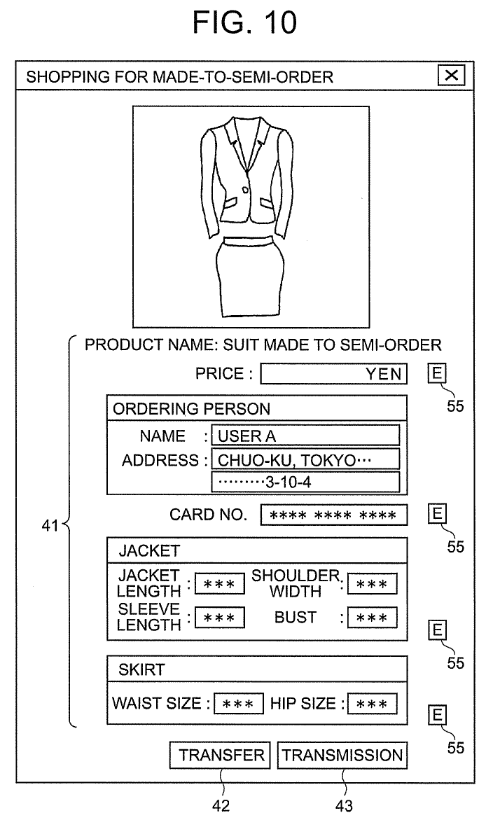

For instance, as illustrated in FIG. 10, “E” buttons (encryption buttons) 55 are provided, and, when the encryption button is selected, character codes defined as the input information are described by HTML in the input form or the transfer form so as to be converted with a predetermined function. At this time, characters such as “******” representing “already inputted” may be displayed in place of the converted codes in the input fields 41.

With this scheme, the first terminal 2 can encrypt the information such as the price and the settlement information selected by the user and can thus transmit the transform form to the second terminal 3. Similarly, the second terminal 3 can encrypt inconvenient items of information selected by the user and can transmit the encrypted information back to the first terminal 2.

### Second Embodiment

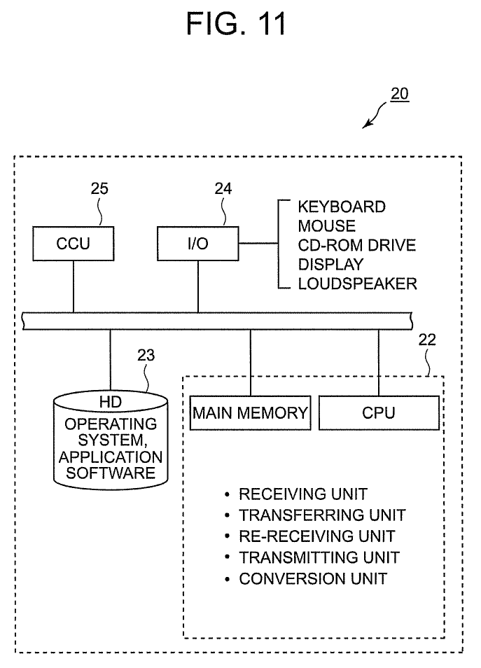

FIG. 11 is a schematic view of a first terminal 20 partly configuring the online shopping system in a second embodiment. The second embodiment is different from the first embodiment in terms of such a point that the first terminal converts the purchase form. Note that other configurations are the same, and therefore the same components are marked with the same numerals and symbols, thus omitting the redundant explanations.

The first terminal 20 is the general-purpose computer including the arithmetic processing unit 22 constructed of the CPU (Central Processing Unit), the main memory, etc., the storage unit (hard disk) 23 stored with the data and the software for the arithmetic process, the input/output (I/O) port 24, the communication control unit (CCU) 25, and so on.

The arithmetic processing unit 22 properly reads the OS and the application program from the storage unit 23 and executes the OS and the application program, thereby functioning also as the receiving unit, the transferring unit, the re-receiving unit, the transmitting unit and a converting unit by arithmetically processing the information inputted from the I/O port 24 and the CCU 25 and the information read from the storage unit 23.

The converting unit converts the transmission destination of the input information with respect to at least some items in the input form into a terminal address, thereby generating the transform form.

On the other hand, the server 1 takes a configuration acquired by omitting the converting unit from the configuration in FIG. 4. Namely, the server 1 in the second embodiment may be a general type of web server including the transmitting unit connecting with the first terminal 20 and transmitting a web page (input form) and a receiving unit receiving the input information to the web page from the first terminal 20.

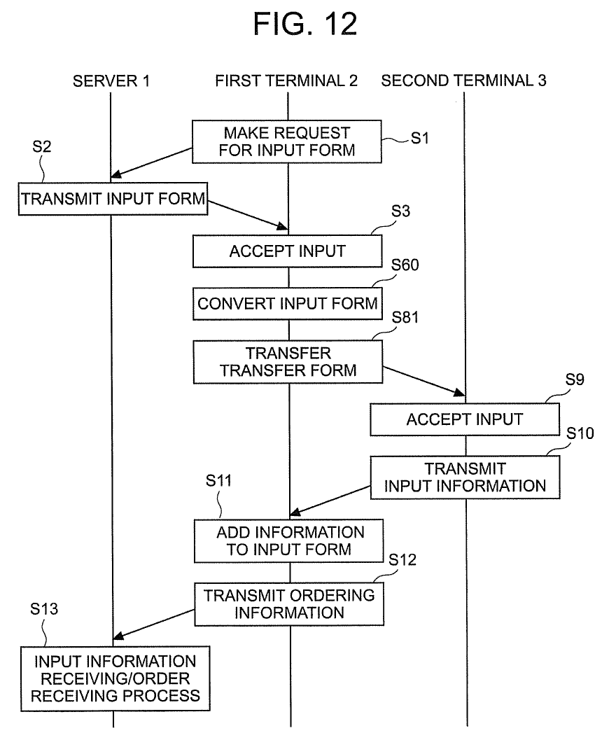

The following is discussion on the transmission information linkup method between the thus-configured server 1 and the thus-configured first terminal 20. FIG. 12 is an explanatory diagram of the transmission information linkup method by way of the second embodiment.

The user of the first terminal 20 browses the shopping site of the server 1 and selects the purchase of the commercial product, in which case the first terminal 20 requests the server 1 for the purchase form (input form) (step 1, which will hereinafter be also abbreviated to as S1).

The transmitting unit of the server 1 receiving the request transmits the purchase form (HTML file) to the requester terminal 20 (S2).

The first terminal 20, of which the receiving unit receives the purchase form, displays the purchase form on the display unit as in FIG. 6. When the user performs inputting by operating the input unit such as the keyboard and the mouse, the terminal 20 receives this input as the input information to respective input fields 41 of the purchase form, and displays the input information in the relevant input fields (S3).

Then, if the user wants to input in linkage with other users, the selection menu is displayed, and the “transfer” is selected. When the “transfer” is indicated, the converting unit of the terminal 20 converts the purchase form into the transfer form (S60). For instance, the input information is transmitted to the server 1 in the case of selecting the transmission button 43 in the purchase form, however, the description of the HTML is changed so that the input information is transmitted to the first terminal 20 in the case of selecting the transmission button 43 in the transfer form. To be specific, the description is changed so as to transmit the information to an IP address or to a mail address of the self-terminal 20.

For example, in the case of sending back the information by mail, the description is given as follows.

<FORM action = ”mailto: mail address of first terminal?subject
= subject of replay mail & body = input information” method =
”POST”>
<div align = ”right”><INPUT type = ”submit” value = ”transmit”
></div></FORM>

At this time, the identifying information for specifying the transferred form is described in the “subject”, and variable that will be substituted for input information of the respective input items is described in the body.

Further, the converting unit inputs, if the inputted input information has already been entered in the purchase form, the input information to the respective input fields in the transfer form.

Then, the transmitting unit of the first terminal 20 transfers the transfer form to the second terminal 3 (S81). For example, if the “transfer” is indicated, the transmitting unit displays the message prompting the user to input the mail address of the transfer destination, and, when the mail address is inputted by the user's operation, transmits the mail attached with the transfer form to the mail address.

Then, the second terminal 3, the first terminal 20 and the server 1 execute the processes from step 9 onward in the same way as in the first embodiment discussed above.

Thus, according to the embodiment, the plurality of users can input the input form in linkage with each other, whereby the plurality of users (the persons concerned: purchasers) can directly input the input information in the case of purchasing gifts and purchasing articles for common use.

Moreover, according to the second embodiment, the first terminal 20 converts the purchase form, and hence even the purchase form for the general shopping site can be transferred to other terminals.

### Fourth Modified Example

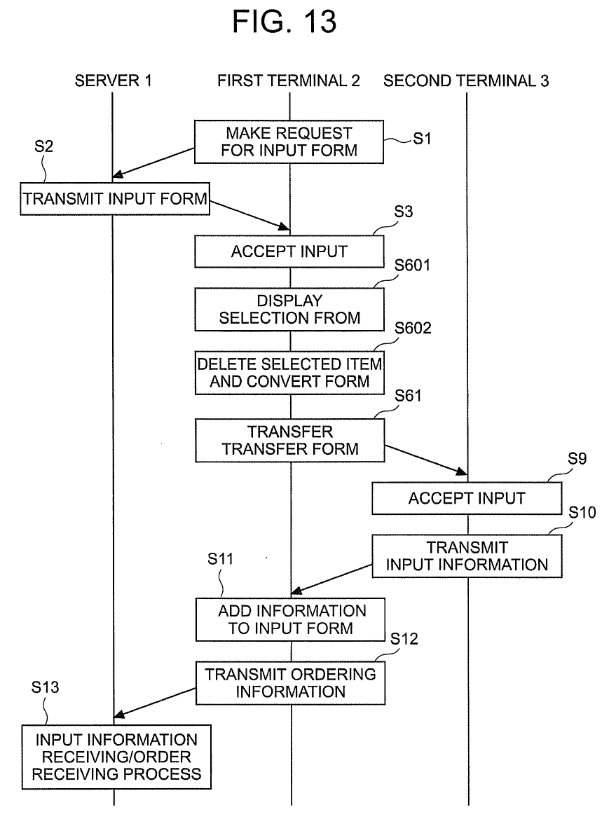

FIG. 13 is an explanatory diagram of a fourth modified example. In the second embodiment discussed above, the same contents are displayed in the purchase form and in the transfer form, however, the fourth modified example enables the display contents to be selected on the first terminal 20. Note that other configurations are the same as in the second embodiment discussed above.

After executing steps 1-3 in the same way as described above, the converting unit of the first terminal 20 in the fourth modified example inputs and displays the received input information in the selection form as illustrated in FIG. 8 (S601).

This selection form is a form which includes a price box 51, a related product display box 52, a discount information display box 53, etc. and selection items (check boxes in this modified example) 54 added to predetermined information fields. The selection form may be stored together with the purchase form in the storage unit 13 beforehand, and the converting unit may generate the selection form by converting the purchase form in a way that adds the selection items 54 to the purchase form. Moreover, the converting unit may execute the conversion of adding the selection items 54 to the input fields to which the input information received from the first terminal is inputted.

Then, when the user selects the check box(s) of the input field(s) that the user wants to delete from the transfer form and chooses the determination button 55, the converting unit of the first terminal 20 deletes, based on the selection information, the checked input box in the purchase form, and converts this form into the transfer form in the same way as step 60 described above (S602).

Subsequently, the transmitting unit of the first terminal 20 transmits the transfer form to the second terminal 3 (S81) and executes the processes from step 9 onward in the same manner as described above.

Thus, according to the fourth modified example, the user of the first terminal 20 deletes the desired box and can transfer the transfer form to the user of the second terminal 3, whereby the display of a related commercial product priced over a budget and arbitrary items of information such as the price can be concealed.

It should be noted that the user selects and deletes the information in the fourth modified example, however, the available scheme is that the information selected by the user may remain undeleted.

### Fifth Modified Example

The second embodiment has exemplified the example of the purchase form for one piece of commercial product, however, a fifth modified example takes, as illustrated in FIG. 9, the purchase form (input form/purchase form) in a format of adding the commercial products purchased by the individual users. Other configurations are the same as those in the second embodiment or the fourth modified example.

When the first terminal 20 receives the purchase form (S3) and when the user inputs the commercial product to be purchased and selects the transfer button, the converting unit of the first terminal 20 converts the purchase form into the transfer form in the same way as in the first embodiment discussed above (S60 or S602), then transmits the transfer form to the second terminal 3, and executes the subsequent processes in the same manner as described above.

Moreover, if the second terminal 3 receiving the input form or the transfer form has the same function as the first terminal 20 has, the second terminal 3 may transfer the received form to further another terminal.

Thus, according to the fifth modified example, the purchase form (input form/purchase form) can be relayed among the plurality of users, and hence the input on the occasion of group-purchasing the commercial product is facilitated.

<Others>

The present invention is not limited to only the illustrated examples given above but can be, as a matter of course, changed in a variety of forms within the scope that does not deviate from the gist of the present invention. Further, the components can be combined to the greatest possible degree.

It should be noted that the embodiments discussed above have exemplified the shopping system, however, the present invention, without being limited to this shopping system, may be a system which transmits, to the server, the input information through the input form as in the case of giving a query to the web site and making an application for electronic procedures to the web site of the administrative agencies.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention have been described in detail, it should be understood that the various changes, substitutions, and alterations could be made hereto without departing from the spirit and scope of the invention.

What is claimed is:

1. A transmission information linkup system comprising:
a server connected to a plurality of terminals via a network; and
a first terminal including:
a receiving unit to receive an input form from said server;
an input unit to input information to the input form, corresponding to a user's operation;
a transferring unit to transfer at least a part of the input form to a second terminal;
a re-receiving unit to receive input information to the input form from said second terminal; and
a transmitting unit to transmit, to said server, the input information received from said second terminal and the input information corresponding to the user's operation as input information to the input form,
wherein said server includes a transmitting unit to transmit the input form to said first terminal, and a receiving unit to receive the input information from said first terminal.

2. The transmission information linkup system according to claim 1, wherein said server further includes a storage unit to store input information to a commercial product purchase form serving as the input form as ordering information of the commercial product, and stores a reservation flag of the commercial product in said storage unit when said first terminal notifies of transferring the purchase form of the commercial product.

3. The transmission information linkup system according to claim 1, wherein said server further includes a converting unit to convert, when said first terminal notifies of transferring the input form, a transmitting destination of input information relating to at least a part of the input form into an address of said terminal, and
said transmitting unit of said server transmits the converted input form to said notifier terminal, and said notifier terminal receives the converted input form and transfers it to said second terminal.

4. The transmission information linkup system according to claim 1, wherein said first terminal further includes a converting unit to convert the transmitting destination of the input information relating to at least a part of the input form into a self-terminal address, and transfers the converted input to said second terminal.

5. The transmission information linkup system according to claim 3, wherein said converting unit, when converting the input form, converts the input form by extracting elements selected by a user or by deleting the elements selected by the user.

6. The transmission information linkup system according to claim 1, wherein said transmitting unit of said server transmits key information for encrypting the input information together with the input form.

7. A transmission information linkup method executed by a system comprising a server and a plurality of terminals including a first terminal server which are connected to each other via a network,
said first terminal executing:
a step of receiving an input form from said server;
a step of inputting input information to an input form, corresponding to a user's operation;
a step of transferring at least a part of the input form to a second terminal;
a step of receiving the input information to the input form from said second terminal; and
a step of transmitting, to said server, the input information received from said second terminal and the input information corresponding to the user's operation as the input information to the input form,
said server executing:
a step of transmitting the input form to said first terminal; and
a step of receiving the input information from said first terminal.

8. The transmission information linkup method according to claim 7, wherein said server further includes a storage unit stored with the input information to a commercial product purchase form serving as the input form as ordering information of the commercial product, and stores a reservation flag of the commercial product in said storage unit when said first terminal notifies of transferring the purchase form of the commercial product.

9. The transmission information linkup method according to claim 7, wherein said server converts, when said first terminal notifies of transferring the input form, a transmitting destination of input information relating to at least the part of the input form into an address of the notifier terminal, and transmits the converted input form to said notifier terminal, and
said notifier terminal receives the converted input form and transfers the input form to said second terminal.

10. The transmission information linkup method according to claim 7, wherein said first terminal converts the transmitting destination of input information relating to at least a part of the input form into a self-terminal address, and transfers the converted input form to said second terminal.

11. The transmission information linkup method according to claim 8, wherein when converting the input form, the input form is converted by extracting elements selected by a user or by deleting the elements selected by the user.

12. The transmission information linkup method according to claim 7, wherein key information for encrypting the input information is transmitted together with the input form.

13. A terminal configuring a transmission information linkup system by connecting with a server via a network, said terminal comprising:
a receiving unit to receive an input form from said server;
an input unit to input information to the input form, corresponding to a user's operation;
a transferring unit to transfer at least apart of the input form to a second terminal;
a re-receiving unit to receive input information to the input form from another terminal; and
a transmitting unit to transmit, to said server, the input information received from said another terminal and the input information corresponding to the user's operation as input information to the input form.

14. A program operated by a terminal configuring a transmission information linkup system by connecting with a server via a network,
said program to make said terminal execute:
a step of receiving an input form from said server;
a step of inputting input information to the input form, corresponding to a user's operation;
a step of transferring at least a part of the input form to a second terminal;
a step of receiving input information to the input form from another terminal; and
a step of transmitting, to said server, the input information received from said another terminal and the input information corresponding to the user's operation as input information to the input form.
